(19) United States
(12) Patent Application Publication
(10) Pub. No.: US 2005/0091173 A1
(43) Pub. Date: Apr. 28, 2005

(54) Method and system for content distribution

(75) Inventor: Jukka Alve, Helsinki (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 10/691,621

(22) Filed: Oct. 24, 2003

(51) Int. Cl. H04L 9/00

(52) U.S. Cl. 705/71

(57) ABSTRACT

A first device transfers to a second device content that is encrypted with a content key. The second device requests access to the content from an authorized agent. Upon a determination that any conditions for approving such a request are satisfied, the authorized agent decrypts a superdistribution key with its private key, and encrypts the resultant content key with the public key of the second device. This encryption produces a protected content key, which is sent to the second device. Upon receipt of this protected content key, the second device will be able to access the content by decrypting the protected content key with the private key of the second device. At this point, the second device may decrypt the content with the content key.

### FIELD OF THE INVENTION

The present invention relates to communications. More particularly, the present invention relates to techniques for managing the distribution of content.

### BACKGROUND OF THE INVENTION

Content, such as television broadcasts, Internet content, and content stored on prerecorded media are valuable commodities in the current economy. Accordingly, there is an interest in protecting such content from illegal copying. Presently, content may be delivered from a content distributor to particular devices in various formats. For example, content may be delivered in an unprotected or encrypted manner. Also, content may be protected using conditional access (CA) or digital rights management (DRM) technologies. However, there is currently a need for techniques that manage the authorized distribution of content among multiple devices once such content is delivered.

It is desirable for such techniques to be backwards compatible with existing receiver design conventions. This is particularly important in a broadcast scenario, in which existing legacy receivers must still be able to access the broadcast, but improved copy protection is required of new devices that are capable of making digital recordings of the broadcast content. One such convention requires receivers to protect received content by encrypting it upon receipt. Current proposals for such encryption by receivers involve the use of random numbers as encryption keys. These encryption keys are called content keys. Once the content is encrypted, the receivers protect the content keys by encrypting them. This encryption can be performed with a device key when the associated content is bound to a particular device. Alternatively, this encryption can be performed with a domain key when the associated content is bound to a set of devices, referred to as a domain.

An entity called an authorized agent has been proposed. This entity is allowed to perform functions such as the modification of usage rules associated with particular content, as well as the modification of the binding of content to a device or a set of multiple devices also known as a domain. Additionally, an authorized agent may be permitted to modify a domain. It is desirable to use an authorized agent to provide for the distribution of delivered content among multiple devices.

### SUMMARY OF THE INVENTION

The present invention is directed to systems and methods of facilitating secure redistribution of content from a first remote device to a second remote device, or alternatively from a first domain to a second domain. This redistribution occurs if the conditions for such redistribution (superdistribution) have been met, as determined by an entity called an authorized agent.

A first device receives content from a content source. The content may be already be encrypted at this point, or it may be in the clear. If the content is encrypted, it may first be decrypted, or alternatively, the original encryption may be maintained but another layer of encryption may be applied on top of it.

According to aspects of the present invention, the content is encrypted with a locally generated encryption key, referred to as content key, after it is received in the first device. This locally generated key is protected by further encrypting it with the public key of the first device or the domain key, depending on the type of binding (e.g., device binding or domain binding) is employed. Additionally, the locally generated encryption key will be protected by encrypting it with the authorized agent's public key. This protected content key is called a “superdistribution key.” The first device may receive the superdistribution key along with the content.

According to further aspects of the present invention, the content key is not locally generated. For instance, the first device may receive content already encrypted with the content key. Also, the first device may receive the content key encrypted in a manner such that the first device may decrypt it. For example, the content key may be encrypted with a public key of the first device.

If domain binding is employed, a second device belonging to the same domain may obtain access to the content simply by requesting the encrypted content and the protected content key from the first device. Since the devices share the same domain key, the second device is able to decrypt the protected content key with the domain key. At this point, the second device is able to decrypt the content with the content key.

In certain situations, the second device is not able to decrypt the content. One such situation occurs when device binding is employed. Another such situation occurs when domain binding is employed and the second device doesn't belong to the same domain as the first device. In this case, the first and second devices do not share the same domain key. Therefore, in these situations, the second device can not decrypt the content because it does not possess either the private key of the first device or the domain key of the first device.

The present invention provides for such situations. In particular, the second device may request access to the content from the authorized agent. This may involve sending to the authorized agent the public key of the second device and/or the superdistribution key. Upon a determination that any conditions for approving such a request (e.g., payment) are satisfied, the authorized agent will decrypt the superdistribution key with its private key, and encrypt the resultant content key with the public key of the second device. This encryption produces a protected content key, which is sent to the second device. Upon receipt of this protected content key, the second device will be able to access the content by decrypting the protected content key with the private key of the second device. At this point, the second device may decrypt the content with the content key.

From a security point of view, it is important to ensure that whenever a secret (such as a content key) is encrypted with a public key, the public key belongs to a trusted entity. Thus, in embodiments of the present invention, the public key of the authorized agent, as well as the public key of the device, are embedded in digital certificates. These digital certificates have been signed by a trusted certificate authority and prove that the public keys actually belong to the trusted device and the trusted authorized agent. If the signature checking of the certificate fails, the device or the authorized agent shall refuse to carry out the described operations.

According to aspects of the present invention, the second device may receive one or more usage rules from the first remote device. These usage rules correspond to the content received from the first device. The second device may transmit these usage rules to the authorized agent. In return, the second device may receive one or more modified usage rules from the authorized agent, which also correspond to the content received from the first remote device.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an operational environment, in which content may be distributed according to the present invention;

FIG. 2 is a block diagram of a first operational scenario;

FIG. 3 is a block diagram of a device implementation that may be employed in the first operational scenario;

FIGS. 4A and 4B are block diagrams of device and authorized agent implementations that may be employed in the first operational scenario;

FIG. 5 is a block diagram of a second operational scenario;

FIG. 6 is a block diagram of a device implementation that may be employed in the second operational scenario;

FIG. 7 is a block diagram of device and authorized agent implementations that may be employed in the second operational scenario;

FIG. 8 is a block diagram of a third operational scenario;

FIG. 9 is a block diagram of a device implementation that may be employed in the third operational scenario;

FIG. 10 is a block diagram of device and authorized agent implementations that may be employed in the third operational scenario;

FIG. 11 is a block diagram of a fourth operational scenario;

FIG. 12 is a block diagram of a device implementation that may be employed in the fourth operational scenario;

FIG. 13 is a block diagram of device and authorized agent implementations that may be employed in the fourth operational scenario;

FIG. 14 is a block diagram of an access module and a user output module;

FIG. 15 is a flowchart of a process of the present invention;

FIG. 16 is a flowchart of an operational sequence that may be performed by an authorized agent; and

FIG. 17 is a block diagram of a computer system.

### DETAILED DESCRIPTION OF THE PREFERRED EMBODIMENTS

I. Operational Environment

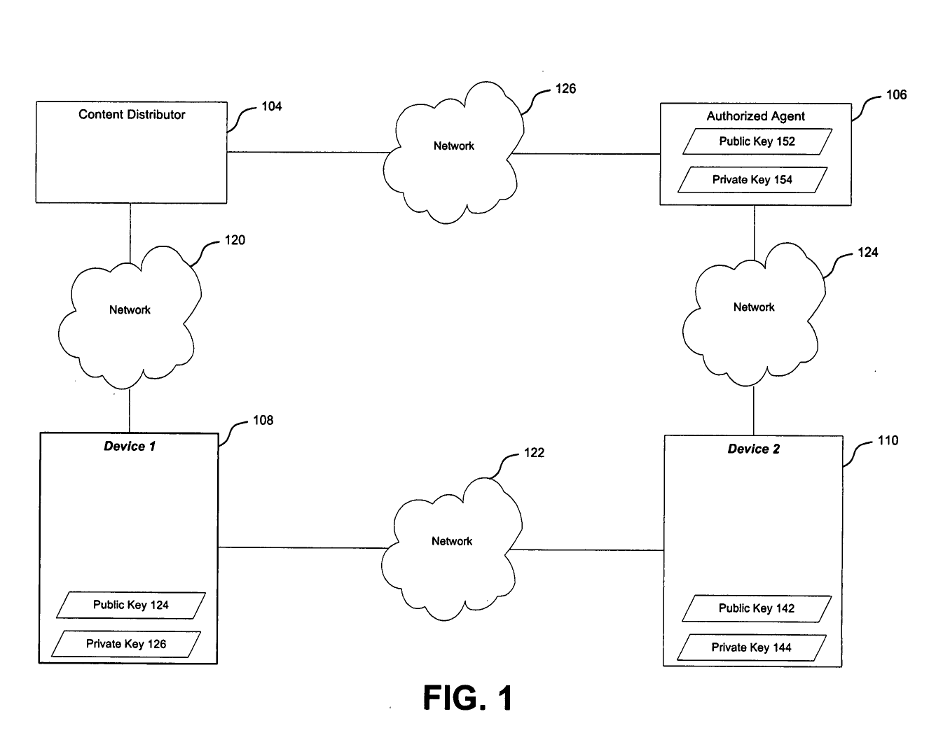

Before describing the invention in detail, it is helpful to describe an environment in which the invention may be used. Accordingly, FIG. 1 is a diagram of an operational environment where content may be distributed among devices according to the present invention. This environment includes a content distributor 104, an authorized agent 106, a first device 108, and a second device 110. Devices 108 and 110 may be associated with a single user or different users.

Content distributor 104 may include a content provider and/or a service provider, which transmits content items to one or more devices. Examples of content items include (but are not limited to) video broadcasts, multimedia content, hypertext documents, and files. Content distributor 104 may be, for example, a digital video broadcaster. Such transmissions may be in either protected (e.g., conditional access encrypted) or unencrypted formats.

FIG. 1 shows that public and private encryption key pairs are associated with devices 108 and 110. In particular, first device 108 has a public key 124 and a corresponding private key 126. Second device 110 has a public key 142 and a corresponding private key 144. In addition, a public key 152 and a corresponding private key 154 are associated with authorized agent 106. With corresponding public and private keys, these devices may employ asymmetric encryption techniques to encrypt and decrypt information, such as content items and encryption keys.

Various networks couple the devices of FIG. 1. For instance, a network 120 couples content distributor 104 and first device 108, a network 122 couples first device 108 and second device 110, a network 124 couples second device 110 and authorized agent 106, and a network 126 couples authorized agent 106 and content distributor 104.

Networks 120, 122, 124, and 126 may each be any suitable network that enables the transfer of information between the coupled devices and entities. For instance, network 120 may be a broadcast network. Examples of broadcast networks include terrestrial and satellite wireless television distribution systems, such as DVB-T, DVB-C, DVB-H (DVB handheld), ATSC, and ISDB systems. Network 120 may also be a broadcast cable network, such as a Data Over Cable Service Interface Specification (DOCSIS) network. Alternatively, network 120 may be a packet-based network, such as the Internet.

As a further example, one or more of networks 120, 122, 124, 126 may be wireless cellular networks. In addition, one or more of these networks may be short-range proximity networks, which employ technology, such as Bluetooth. Accordingly, one or more of devices 104, 106, 108, and 110 may be implemented as mobile phones. Although FIG. 1 illustrates distinct networks, in embodiments, a single network may replace two or more of networks 120, 122, 124, and 126.

Moreover, between the devices and entities of FIG. 1, there may be in some embodiments of the invention not only a single network but two or more networks. These networks may be used for messaging and/or (content) data transfer between the devices and entities. For example, a user terminal (such first device 108) may comprise a DVB receiver, a mobile phone and in addition have a Bluetooth connection.”

As described above, the present invention allows for content to be distributed among devices. For example, content distributor 104 may transmit a content item that is authorized for reception by first device 108. Upon receipt of this content item, the user of first device 108 may desire to forward this content to second device 110. According to the present invention, first device 108 may transfer the content item (as well as other associated information) to second device 110. However, for device 110 to use (e.g., access) the content item, it must first obtain information from authorized agent 106. Basically, second device 110 may get information from the original content provider/owner/distributor, but authorized agent 106 can act on behalf of the content provider to allow device 110 to access the information.

Authorized agent 106 is involved in managing the distribution of content among devices. Authorized agent 106 is trusted by content distributor 104 and is authorized to act on its behalf. Thus, when authorized agent 106 is implemented as an entity distinct from content distributor 104, it may perform acts that, in principle, are imputed to content distributor 104. Examples of such acts include changing existing usage rules, and creating new usage rules.

However, content distributor 104 may set limits to the authorization given to authorized agent 106. For instance, content distributor 104 may impose temporal limits on this authorization. Such temporal limits may specify a particular time (e.g., month/day/year) at which this authorization expires. In addition, content distributor 104 may revoke this authorization at any time.

Moreover, any authorization that content distributor 104 grants to authorized agent 106 may include various limitations and/or qualifications. For example, content distributor 104 may limit authorization to certain types of content. Such content types include low-priced content, obsolete content, lower grade content, or any combination of these. Thus, content distributor 104 may impose restrictions (or limited authority) upon authorized agent 106 so that it is not allowed to perform all of the functions that content distributor 104 may perform.

Authorized agent 106 may be locally accessible by second device 110. For example, authorized agent 106 may be positioned at a publicly available location, such as a kiosk that is near second device 110. Accordingly, in such implementations, network 124 may be an ad hoc proximity network, such as a Bluetooth network. Further, authorized agent 106 may be located in a different area or region than content distributor 104. In such locations, the ‘original’ owner of rights (i.e., content distributor 104) may not be accessible. Thus, authorized agent 106 provides for local content access instead of central content access from content distributor 104. This feature relieves communications and processing loads from content distributor 104.

Although FIG. 1 only shows a single content distributor, authorized agent 106 may be trusted by multiple content distributors. Similarly, although FIG. 1 only shows a single authorized agent, content distributor 104 may trust multiple authorized agents. Also, in embodiments of the present invention, content distributor 104 may perform the role of authorized agent 106.

As described above, authorized agent 106 may be implemented in a mobile phone. In such implementations, authorized agent 106 may operate as a personal authorized agent for an individual, or a shared authorized agent between multiple people (e.g., family members).

As described above, content distributor 104 transmits content items. Each of these content items may be associated with one or more usage rules. These usage rules state the rights of the user or possessor of the corresponding content items to render, copy, store and/or transfer the received content. For example, usage rules may restrict the rendering of content items to a prescribed number of times. In addition, usage rules may restrict the transfer of content items to other devices and/or other users.

Usage rules may also set temporal restrictions regarding the use of corresponding content items. For example, a temporal usage rule may require that a content item shall only be stored for a prescribed period of time. In addition, usage rules may only have temporally limited validity.

In embodiments of the present invention, usage rules may be expressed as one or more data files. These data files may be in various formats. For example, the data files may be in an XML-based markup language such as the Open Digital Rights Language (ODRL) or the eXtensible rights Markup Language (XrML). The data files may also be directly in XML. ODRL provides for the expression of terms and conditions involving content, such as permissions, constraints, and obligations. XrML provides techniques for specifying and managing rights and conditions associated with content.

Content distributor 104 may transmit one or more usage rules along with a content item. The usage rules may be expressed in a voucher. Such a voucher may include data identifying the corresponding content item, the content distributor, the content distributor, and the usage rules. In addition, a voucher may include one or more encryption keys either in plain form (public keys) or encrypted. The voucher may have restricted validity.

Alternatively, a content item and its associated usage rules and/or vouchers may be delivered separately from each other. Thus, a content item and its associated usage rules and/or vouchers may be transmitted at different times, and/or across different media. Such content items, usage rules and vouchers may include pointers. This allows them to be associated with each other when necessary.

II. Operational Scenarios

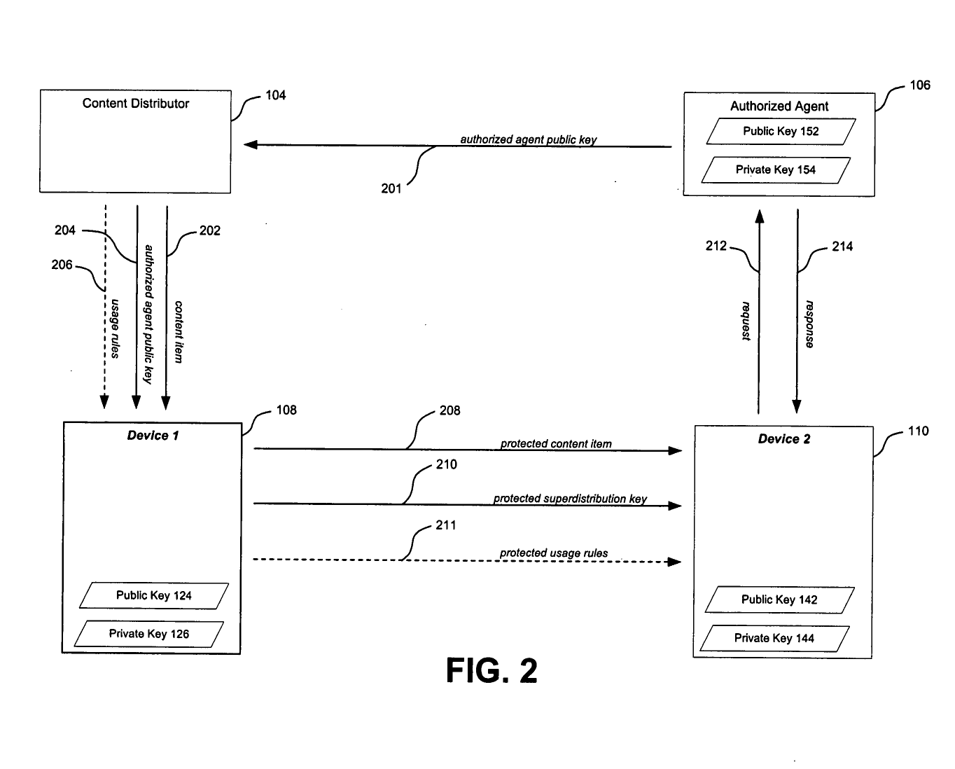

According to the present invention, various scenarios may be employed to distribute content between devices. Examples of such scenarios are illustrated in FIGS. 2-13. In these examples, content is transferred between first device 108 and second device 110. However, these scenarios involve the exchange of information between content distributor 104, first device 108, second device 110, and authorized agent 106. For convenience, FIGS. 2-13 do not illustrate networks 120, 122, 124, and 126. However, these networks may be used to facilitate the communications shown in these drawings.

First Scenario

A first content distribution scenario is shown in FIGS. 2-4. FIG. 2 shows that in this scenario, content distributor 104 receives a transmission 201 from authorized agent 106. Transmission 201 includes public key 152 of authorized agent 106.

Content distributor 104 transmits to first device 108 a content item 202, and an encryption key 204 that is associated with authorized agent 106 (e.g., public key 152). Also, content distributor 104 may send to first device 108 usage rules 206 which correspond to content item 202. Content distributor 104 may transmit this information to first device 108 in either protected or unprotected formats. An example of a protected format is conditional access (CA) encrypted.

Based on this information, first device 108 generates a protected content item 208 and a protected superdistribution key 210, which are sent to second device 110. In addition, first device 108 may generate protected usage rules 211 and send them to second device 110. Protected content item 208 and protected usage rules 211 are each encrypted with a content key generated by first device 108. First device 108 encrypts this content key with encryption key 204 to generate protected superdistribution key 210. As described above, encryption key 204 is associated with authorized agent 106.

Although second device 110 receives protected content item 208, protected superdistribution key 210, and protected usage rules 211, it is unable to access the underlying content of protected content item 208. This is because protected superdistribution key 210 is encrypted with a key that is specific to authorized agent 106, and not accessible by second device 110. Accordingly, second device 110 relies on authorized agent 106 to decrypt protected content item 208.

More particularly, second device 110 sends a content key request 212 to authorized agent 106. Request 212 includes protected superdistribution key 210. In addition, request 212 may include public key 142 of second device 110. Also, request 212 may include protected usage rules 211.

In response to request 212, authorized agent 106 generates a response 214, which is sent to second device 110. Response 214 includes a secure content key. This secure content key is the content key generated by first device 108, but encrypted with public key 142 of second device 110.

At this point, second device 110 may decrypt the secure content key received in response 214 with private key 144. As a result of this decryption, second device 110 obtains the key used by first device 108 when encrypting protected content item 208. With this content key, second device 110 may decrypt and access the underlying content of protected content item 208 (i.e., content item 202).

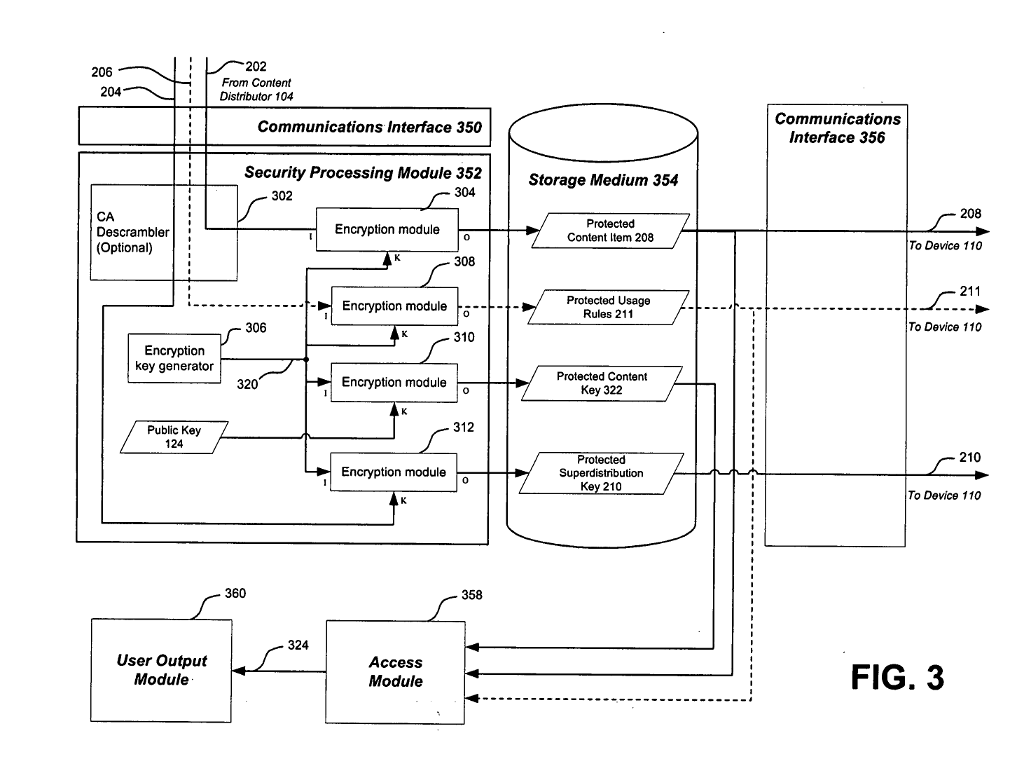

FIG. 3 is a block diagram of an exemplary first device 108 implementation that may be employed in the scenario of FIG. 2. This implementation includes a first communications interface 350, a security processing module 352, a storage medium 354, and a second communications interface 356. In addition, the implementation of FIG. 3 includes an access module 358 and a user output module 360. In embodiments of the present invention, first device 108 implementations may have further communications interfaces to provide for the transfer of messaging and content across different communications media.

First communications interface 350 includes hardware and/or software to provide for the reception of transmissions from content distributor 104. As shown in FIG. 3, first communications interface 350 receives content item 202, encryption key 204, and usage rules 206. This information is transferred to security processing module 352.

Security processing module 352 performs various operations involving, for example, encryption, decryption, and key generation. As shown in FIG. 3, security processing module 352 includes an optional CA descrambler 302, and an encryption key generator 306 (e.g., a random number generator). In addition, security processing module 352 includes encryption modules 304, 308, 310, and 312. These modules may be implemented in hardware, software, firmware, or in any combination thereof.

If content distributor 104 employs conditional access protection, its transmissions are at least partly scrambled. Accordingly, descrambler 302 descrambles content item 202, encryption key 204, and usage rules 206.

Encryption key generator 306, generates an internally generated encryption key 320, which is sent to encryption modules 304, 308, 310, and 312. As shown in FIG. 3, each of these encryption modules has an input interface (indicated with an “I”) for receiving data, and an input interface (indicated with a “K”) for receiving an encryption key. In addition, each of these modules includes an output interface (indicated with an “O”) for outputting encrypted data. In embodiments of the present invention, encryption key generator 306 includes a random number generator, which generates a random number. Encryption key 320 may be (or be based upon) this random number.

Encryption module 304 receives and encrypts content item 202 using, for example, internally generated content key 320. This encryption generates protected content item 208. Similarly, encryption module 308 receives and encrypts usage rules 206 using content key 320. This encryption generates protected usage rules 211.

Security processing module 352 encrypts content key 320 in two different ways. In the first way, encryption module 310 encrypts content key 320 with public key 124. This encryption generates a protected content key 322, which first device 108 may use for subsequent decryption of content item 202. In the second way, encryption module 312 encrypts content key 320 with encryption key 204. As described above with reference to FIG. 2, encryption key 204 is a key (such as public key 152) that is associated with authorized agent 106. This encryption generates protected superdistribution key 210.

Storage medium 354 may include random access memory (RAM), read only memory (ROM), flash memory, disk storage, and/or other suitable storage media. As shown in FIG. 3, storage medium 354 stores protected content item 208, protected usage rules 211, protected superdistribution key 210, and protected content key 322.

Protected content item 208, protected usage rules 211, and protected superdistribution key 210 are sent to communication interface 356 for transmission to second device 110. FIG. 3 shows this information being sent from storage medium 354. However, protected content item 208, protected usage rules 211, and protected superdistribution key 210 may alternatively be sent directly to communications interface 356 from encryption modules 304, 308, and 312.

Second communications interface 356 includes hardware and/or software that allow for the transmission of information to second device 110. As shown in FIG. 3, second communications interface 356 sends protected content item 208, protected usage rules 211, and protected superdistribution key 210 to second device 110.

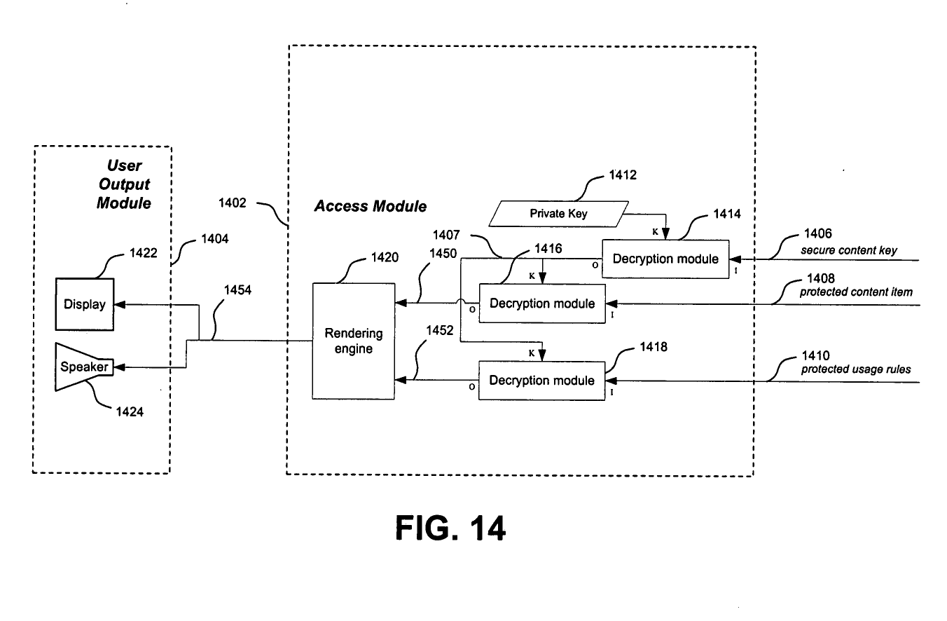

The first device implementation of FIG. 3 includes an access module 358 and a user output module 360. Access module 358 may receive protected content item 208, protected usage rules 211, and protected content key 322. From these inputs, access module 358 decrypts protected content item 208. In addition, access module 358 may decode or render decrypted content item 208 (i.e., content item 202) into an output signal 324. User output module 360 receives signal 324 and outputs it to a user of first device 108. Implementations of access module 358 and user output module 360 are described in greater detail below with reference to FIG. 14.

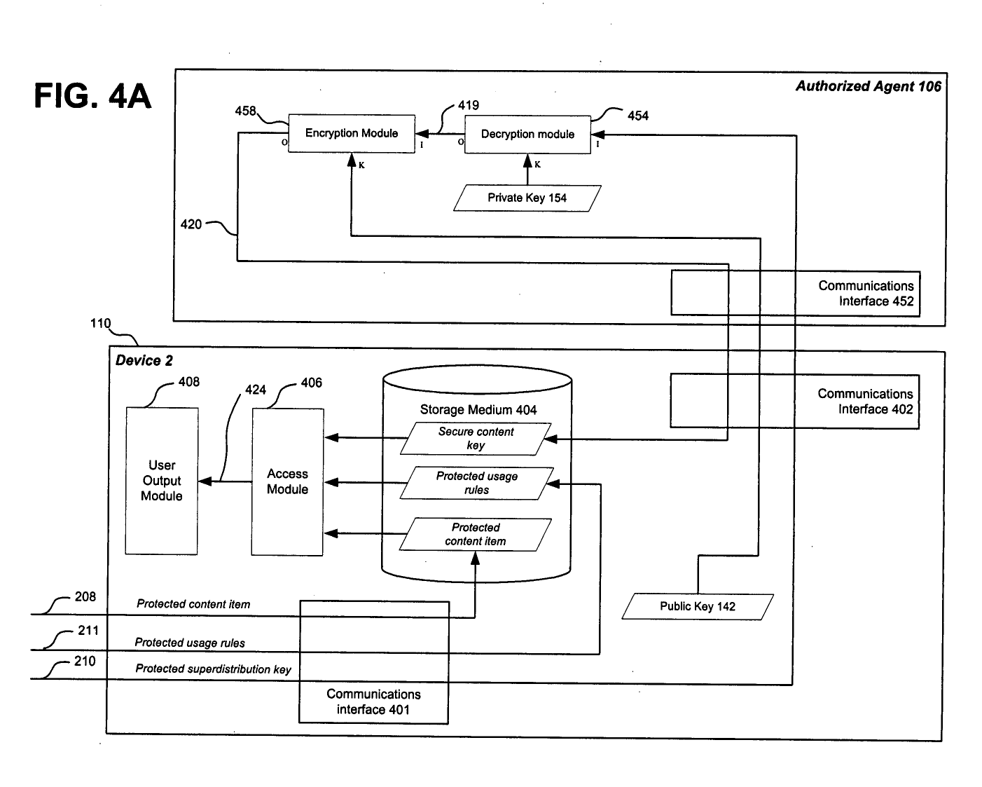

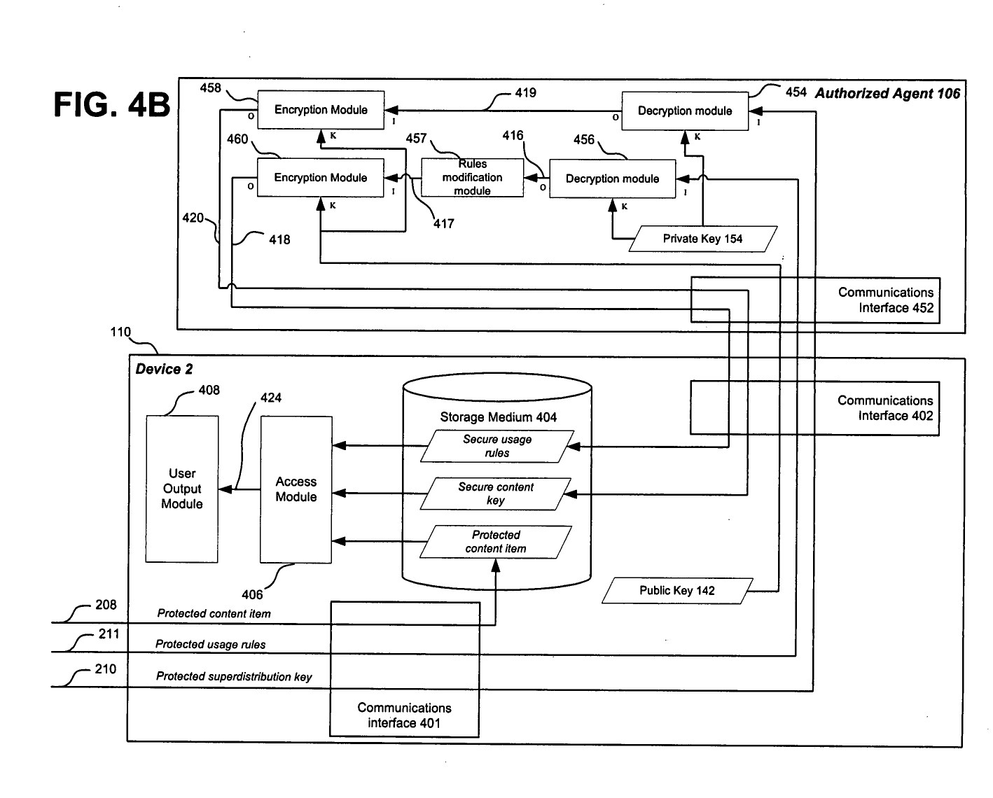

FIGS. 4A and 4B are block diagrams showing exemplary implementations of second device 110 and authorized agent 106 that may be employed in the scenario of FIG. 2. In addition, FIGS. 4A and 4B show interactions between second device 110 and authorized agent 106 according to this scenario.

The second device 110 implementation of FIG. 4A includes communications interfaces 401 and 402, a storage medium 404, an access module 406, and a user output module 408. In embodiments of the present invention, second device 110 implementations may have further communications interfaces to provide for the transfer of messaging and content across different communications media.

Communications interface 401 includes hardware and/or software that allow for the reception of transmissions from first device 108. As shown in FIG. 4A, communications interface 401 receives protected content item 208, protected superdistribution key 210, and protected usage rules 211. Interface 401 then forwards this information to storage medium 404.

Storage medium 404 may include random access memory (RAM), read only memory (ROM), flash memory, disk storage, and/or other suitable storage media. As shown in FIG. 4A, storage medium 404 receives and stores protected content item 208 and protected usage rules 211.

Communications interface 402 includes hardware and/or software that allow for the exchange of information with authorized agent 106. Communications interface 402 receives protected superdistribution key 210 from interface 401. In addition, communications interface 402 may receive public key 142. Communications interface 402 then places this information in an appropriate format for transmission to authorized agent 106 as request 212. Request 212 may comprise one or more transmissions according to various formats and protocols.

Upon receipt of request 212, authorized agent 106 generates a secure content key 420, which is sent to second device 110 as part of response 214. The generation of response 214 is described in greater detail below. As shown in FIG. 4A, communications interface 402 receives secure content key 420 from authorized agent 106 and forwards it to storage medium 404, where it is stored.

Access module 406 may receive protected content item 208, protected usage rules 211, and secure content key 420. FIG. 4A shows access module 406 receiving this information from storage medium 404. However, this information may alternatively be received directly from communications interfaces 401 and 402.

From these received inputs, access module 406 decrypts protected content item 208. In addition, access module 406 may decode or render decrypted content item 208 (i.e., content item 202) into an output signal 424. User output module 408 receives signal 424 and outputs it to a user of second device 110. Implementations of modules 406 and 408 are described in greater detail below with reference to FIG. 14.

The authorized agent 106 implementation of FIG. 4A includes a communications interface 452, a decryption module 454, and an encryption module 458. Communications interface 452 exchanges information with second device 110, such as request 212 and response 214. Accordingly, communications interface 452 includes hardware and/or software that allow for the exchange of information with second device 110.

As described above, request 212 includes protected superdistribution key 210. In addition, request 212 may include public key 142. Communications interface 452 forwards protected superdistribution key 210 to decryption module 454.

Decryption module 454 may be implemented in hardware, software, firmware, or in any combination thereof. As shown in FIG. 4A, decryption module 454 has an input interface (indicated with an “I”) for receiving encrypted data, and an input interface (indicated with a “K”) for receiving an encryption key. In addition, decryption module 454 includes an output interface (indicated with an “O”) for outputting decrypted data. Decryption module 454 decrypts protected superdistribution key 210 with private key 154. This produces a decrypted content key 419 (i.e., content key 320), which is sent to encryption module 458.

Encryption module 458 may be implemented as the encryption modules of FIG. 3. FIG. 4A shows that encryption module 458 receives decrypted content key 419 and encrypts it with public key 142. This results in a secure content key 420, which is sent to communications interface 452 for transmission to second device 110 as part of response 214.

FIG. 4B shows further implementations of second device 110 and authorized agent 106 that may be employed in the scenario of FIG. 2. These implementations are similar to the implementations of FIG. 4A. However, the implementations of FIG. 4B, provide for the exchange of usage rules between devices.

As shown in FIG. 4B, communications interface 401 forwards protected usage rules 211 to second communications interface 402. In turn, communications interface 402 formats and sends protected usage rules 211 to authorized agent 106 as part of request 212.

The authorized agent 106 implementation of FIG. 4B includes additional elements to process protected usage rules 211. These additional elements include a decryption module 456, a rules modification module 457 (also referred to as rules module 457), and an encryption module 460.

Decryption module 456 may be implemented as decryption module 454. Decryption module 456 decrypts protected usage rules 211 with private key 154. This produces decrypted usage rules 416 (i.e., usage rules 206), which are sent to rules modification module 457.

Rules modification module 457 may modify decrypted usage rules 416. For example, rules modification module 457 may modify the domain of the corresponding content item. However, such modifications may be limited to modification restrictions included in decrypted usage rules 416. Accordingly, module 457 may be implemented with hardware, software, firmware, or any combination thereof. As shown in FIG. 4B, module 457 generates modified usage rules 417, which are sent to encryption module 460.

Encryption module 460 may be implemented as the encryption modules of FIG. 3. Encryption module 460 encrypts modified usage rules 417 with public key 142. This results in secure usage rules 418, which are sent to communications interface 452. In turn interface 452 transmits secure usage rules 418 to second device 110 as part of response 214.

At second device 110, FIG. 4B shows that communications interface 402 receives and forwards secure usage rules 418 to storage medium 404. Storage medium 404 may then send secure usage rules 418 to access module 406. Alternatively, communications interface 402 may forward secure usage rules 418 directly to access module 406.

B. Second Scenario

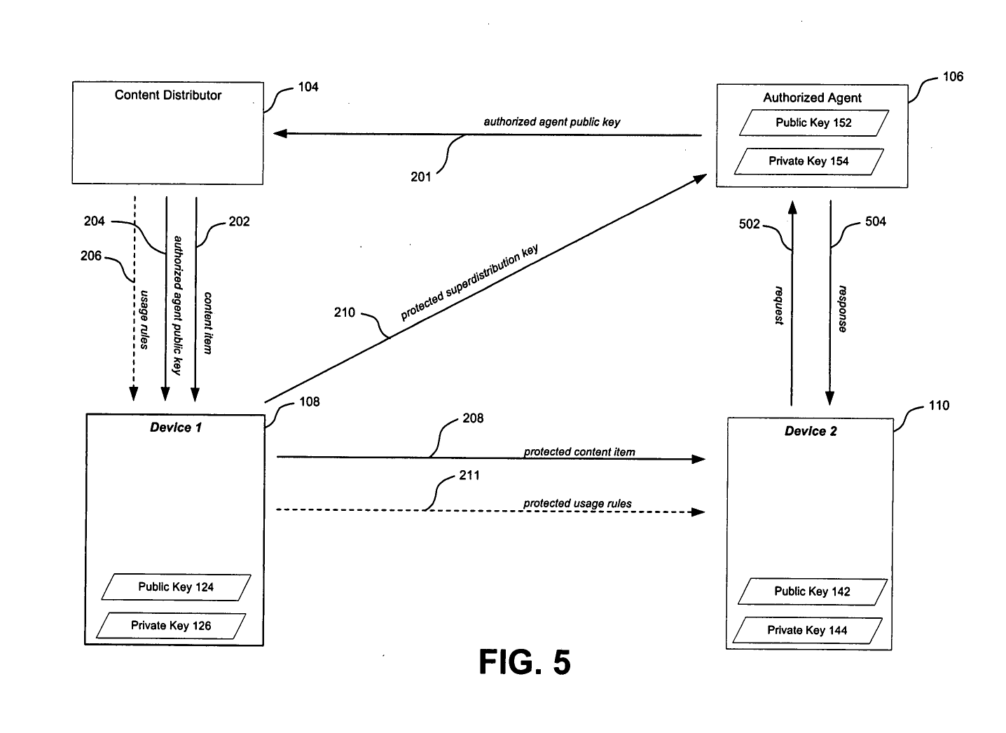

A second content distribution scenario is shown in FIGS. 5-7. This scenario is similar to the first scenario described above with reference to FIGS. 2-4. For instance, content distributor 104 receives a transmission 201 from authorized agent 106 that includes public key 152. Also, content distributor 104 transmits to first device 108 content item 202, encryption key 204, and usage rules 206.

First device 108 receives this information and generates protected content item 208, protected superdistribution key 210, and protected usage rules 211 in the manner described above with reference to FIGS. 2-4. As in the first scenario, protected content item 208 and protected usage rules 211 are sent to second device 110. However, unlike the first scenario of FIGS. 2-4, first device 108 sends protected superdistribution key 210 to authorized agent 106, instead of to second device 110. This key is sent to authorized agent 106 across a network. This network may be one of networks 120, 122, 124, and 126.

After receiving protected content item 208, second device 110 may transmit a content key request 502 to authorized agent 106. Request 502 may include information that identifies the particular content item that corresponds to the requested content key. In addition, request 502 may include public key 142 of second device 110.

In response to request 502, authorized agent 106 generates a response 504. Authorized agent 106 then sends response 504 to second device 110. Response 504 includes a secure content key. This secure content key is the content key generated by first device 108, but encrypted with public key 142 of second device 110.

At this point, second device 110 may decrypt the secure content key from response 504 with private key 144 to obtain the key used by first device 108 when encrypting protected content item 208. With this content key, second device 110 may decrypt and access the underlying content of protected content item 208.

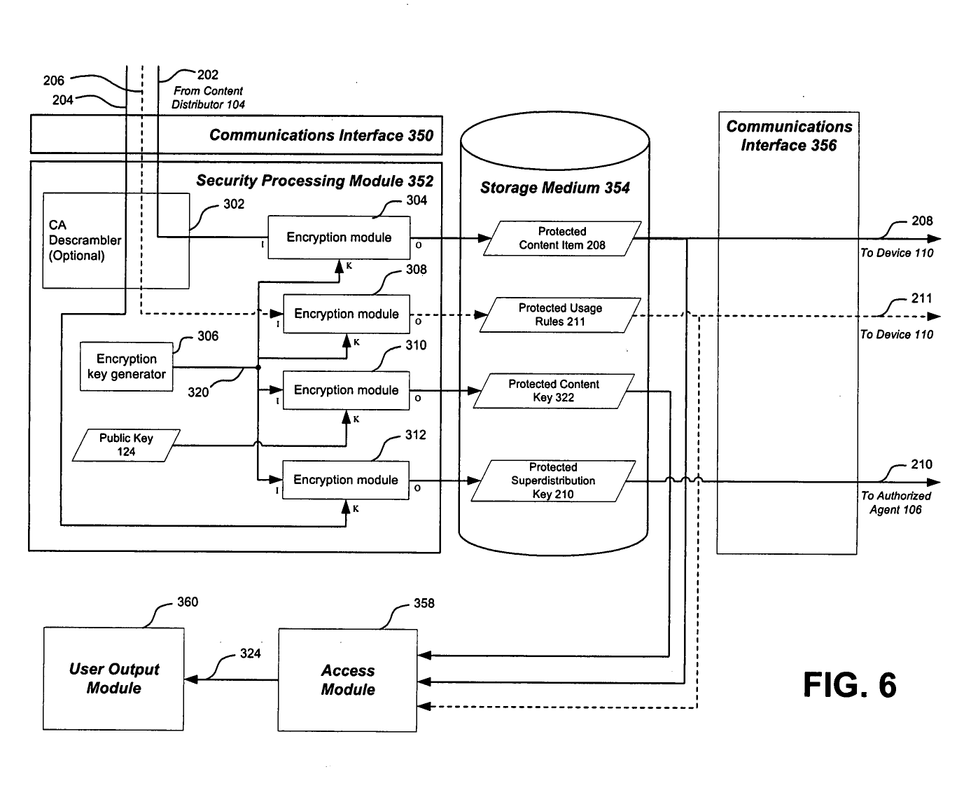

FIG. 6 is a block diagram of an exemplary first device 108 implementation that may be employed in the scenario of FIG. 5. This implementation is similar to the implementation of FIG. 3. However, instead of sending protected superdistribution key 210 to second device 110, second communications interface 356 sends protected superdistribution key 210 to authorized agent 106. Thus, in the implementation of FIG. 6, interface 356 allows for the transmission of information to both second device 110 and authorized agent 106.

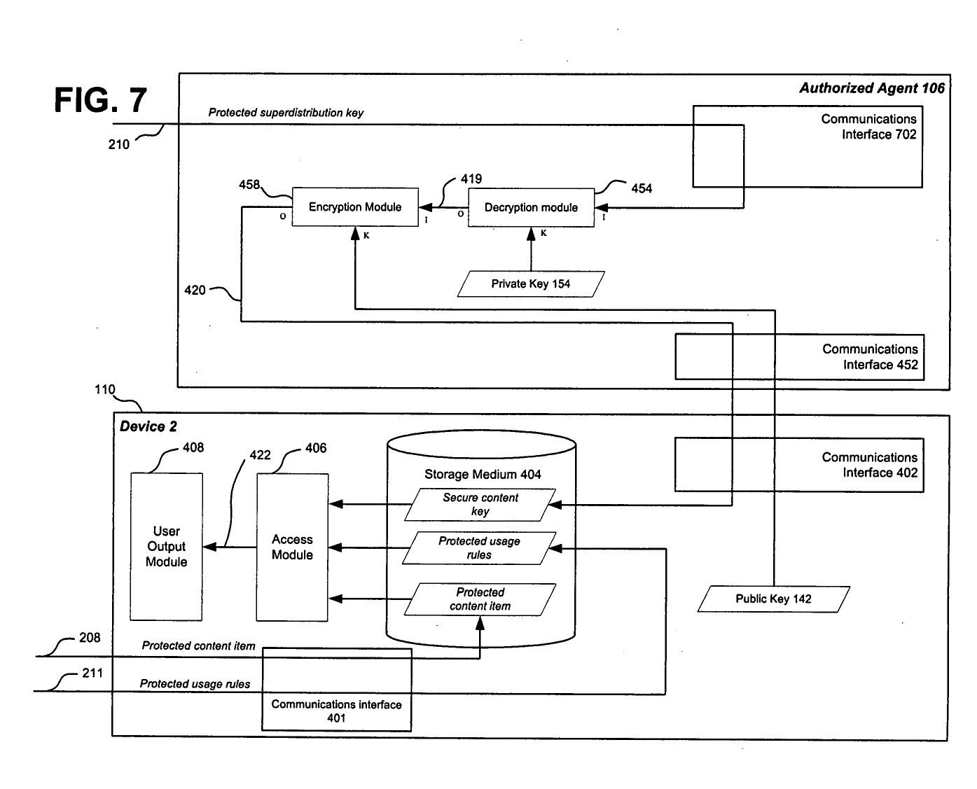

FIG. 7 is a block diagram showing exemplary implementations of second device 110 and authorized agent 106 that may be employed in the scenario of FIG. 5. In addition, FIG. 7 shows interactions between second device 110 and authorized agent 106 according to this scenario.

The implementations of FIG. 7 are similar to the implementations of FIG. 4A. However, in FIG. 7, protected superdistribution key 210 is not sent from second device 110 to authorized agent 106. Instead, authorized agent 106 receives protected superdistribution key 210 from first device 108 via a communications interface 702. Communications interface 702 provides for the exchange of information between first device 108 and authorized agent 106. Interface 702 may be implemented in hardware, software, firmware, or any combination thereof

Decryption module 454 decrypts protected superdistribution key 210 with private key 154. This produces a decrypted content key 419 (i.e., content key 320). Encryption module 458 encrypts decrypted content key 419 with public key 142. Public key 142 may be sent to authorized agent 106 as part of request 502. This encryption produces secure content key 420, which is sent to communications interface 452 for transmission to second device 110 as part of response 504.

C. Third Scenario

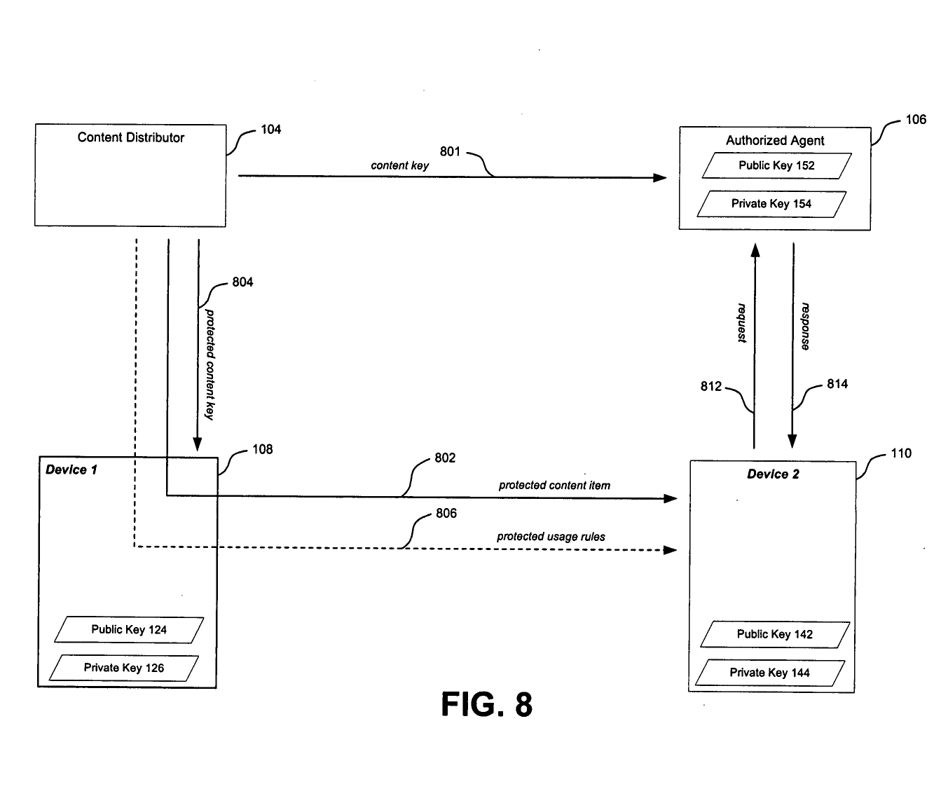

A third content distribution scenario is shown in FIGS. 8-10. In this scenario, content distributor 104 sends a content key 801 to authorized agent 106. Also, content distributor 104 sends to first device 108 a protected content item 802, and a protected content key 804. In addition, content distributor 104 may also send protected usage rules 806 to first device 108. Protected content item 802, protected content key 804, and protected usage rules 806 are each encrypted with content key 801.

As shown in FIG. 8, first device 108 forwards protected content item 802 and protected usage rules 806 to second device 110. However, upon receipt of this information, second device 110 cannot decrypt protected content item 802 and protected usage rules 806, because it does not have access to a necessary encryption key. Accordingly, for second device 110 to decrypt this information, it relies on authorized agent 106.

More particularly, upon receipt of protected content item 802 and protected usage rules 806, second device 110 may send a content key request 812 to authorized agent 106. Request 812 may include an encryption key associated with second device 110, such as public key 142. In addition, request 812 may include information identifying the particular content item that corresponds to the requested content key.

In response to request 812, authorized agent 106 generates a response 814 and sends it to second device 110. Response 814 includes a content key encrypted with a key that is specific to second device 110, (e.g., public key 142). At this point, second device 110 may decrypt protected content item 208.

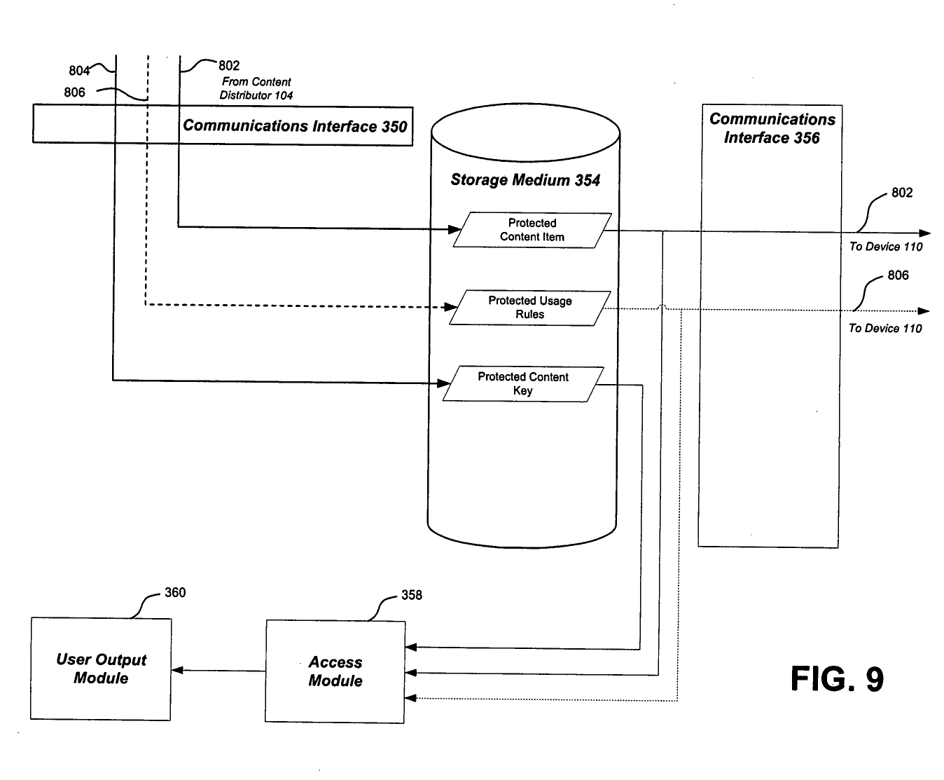

FIG. 9 is a block diagram of an exemplary first device 108 implementation that may be employed in the scenario of FIG. 8. This implementation is similar to the implementation of FIG. 3. However, this implementation does not include a security processing module 352. This is because protected content item 802, protected content key 804, and protected usage rules 806 are received from content distributor 104 in a protected format. More particularly, this information is encrypted with a key associated with first device 108, such as public key 124.

Accordingly, FIG. 9 shows first communications interface 350 sending protected content item 802, protected content key 804, and protected usage rules 806 to storage medium 354. In addition, FIG. 9 shows storage medium 354 sending protected content item 802 and protected usage rules 806 to second communications interface 356 for transmission to second device 110. However, in alternative implementations, this information may be sent directly from first communications interface 350 to second communications interface 356.

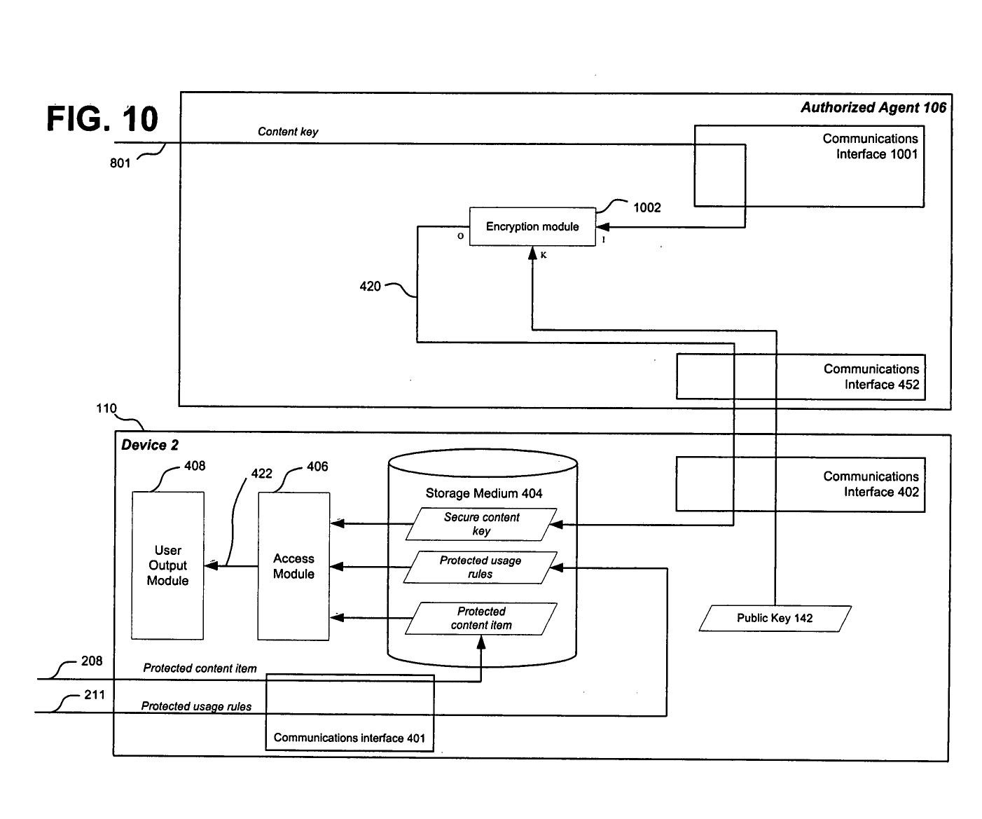

FIG. 10 is a block diagram showing exemplary implementation of second device 110 and authorized agent 106 that may be employed in the scenario of FIG. 8. In addition, FIG. 10 shows interactions between second device 110 and authorized agent 106 according to this scenario.

The implementations of FIG. 10 are similar to the implementations of FIG. 4A. However, in FIG. 10, protected superdistribution key 210 is not sent from second device 110 to authorized agent 106. Instead, authorized agent 106 receives content key 801 from first device 108 via a communications interface 1001. Communications interface 1001 provides for the exchange of information between first device 108 and authorized agent 106. Interface 1001 may be implemented in hardware, software, firmware, or any combination thereof.

Within authorized agent 106, an encryption module 1002 encrypts content key 801 with public key 142. As shown in FIG. 10, public key 142 may be sent to authorized agent 106 as part of request 812. This encryption produces secure content key 420, which is sent to communications interface 452 for transmission to second device 110 as part of response 814.

D. Fourth Scenario

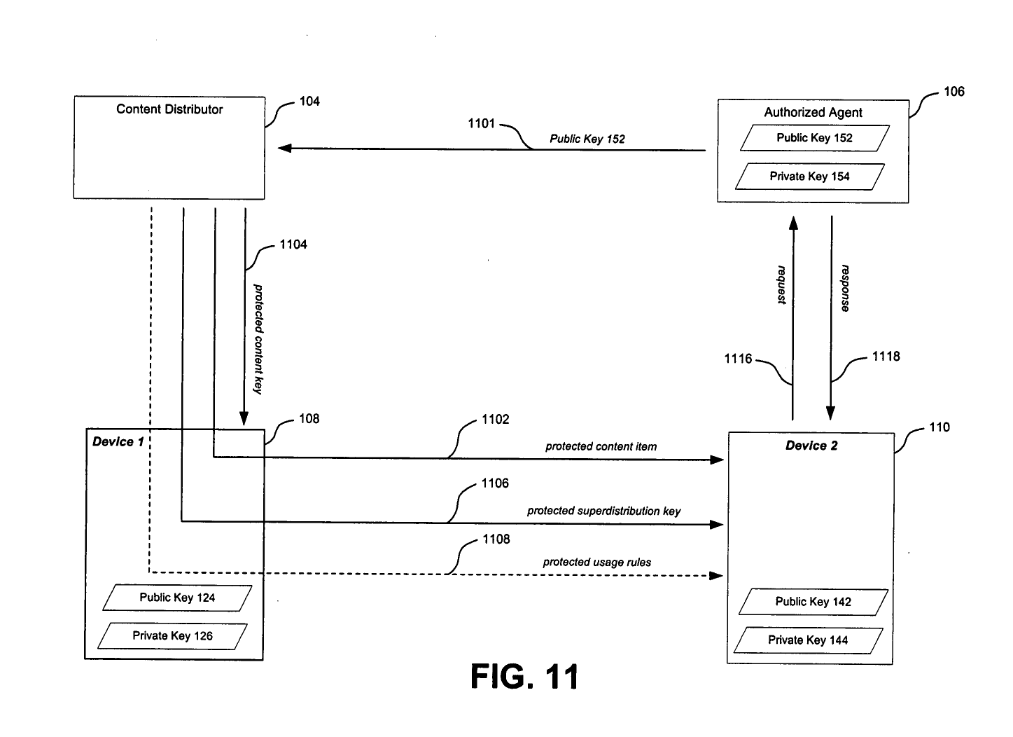

A fourth content distribution scenario is shown in FIGS. 11-13. In this scenario, authorized agent 106 sends its public key 152 to content distributor 104 in a transmission 1101. Content distributor 104 sends to first device 108 a protected content item 1102, a protected content key 1104, and a protected superdistribution key 1106. As shown in FIG. 11, content distributor 104 may also send to first device 108 protected usage rules 1108.

Protected content item 1102 and protected usage rules 1108 are encrypted with a content key that is generated or provided by content distributor 104. This content key is encrypted with public key 124 to produce protected content key 1104. In addition, this content key is also encrypted with public key 152 to produce protected superdistribution key 1106.

As shown in FIG. 11, first device 108 may send protected content item 1102, protected superdistribution key 1106, and protected usage rules 1108 to second device 110. However, upon receipt of this information, second device 110 cannot decrypt protected content item 1102 and protected usage rules 1108, because it does not have access to a necessary encryption key. Accordingly, for second device 110 to decrypt this information, it relies on authorized agent 106.

Second device 110 transmits a content key request 1116 to authorized agent 106. Request 1116 includes protected superdistribution key 1106. In addition, request 1116 may include an encryption key associated with second device 110, such as public key 142.

In response to request 1116, authorized agent 106 generates a response 1118 and sends it to second device 110. Response 1118 includes a secure content key. This secure content key is the content key used by content distributor to produce protected content item 1102, but it is encrypted with public key 142 of second device 110.

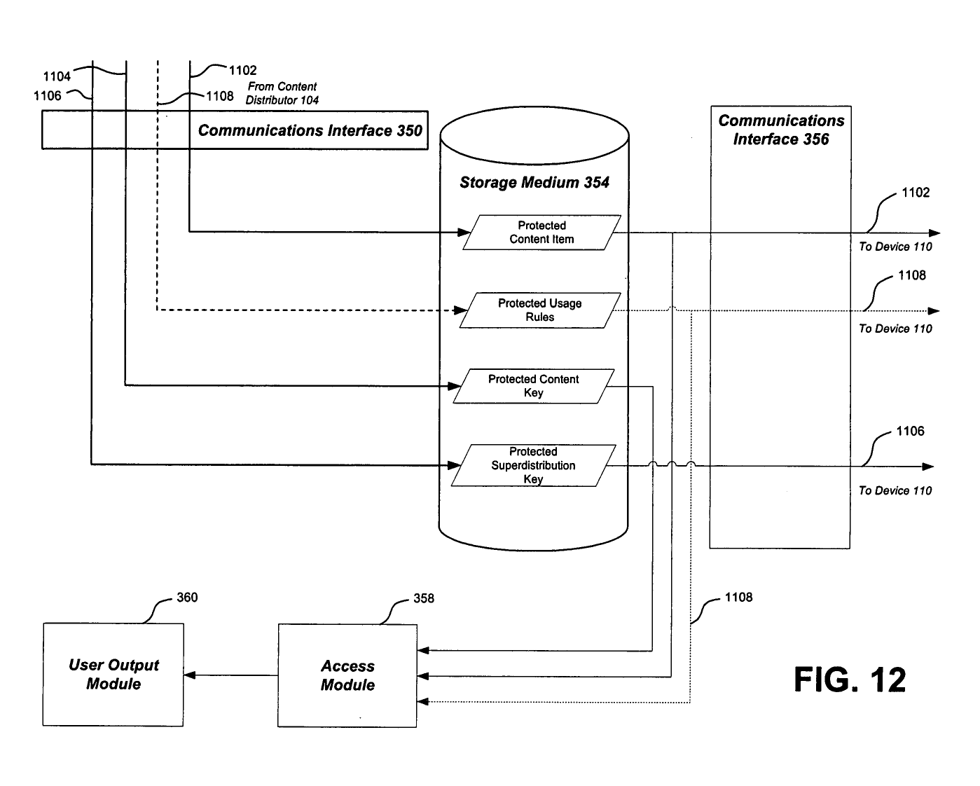

FIG. 12 is a block diagram of an exemplary first device 108 implementation that may be employed in the scenario of FIG. 11. This implementation is similar to the implementation of FIG. 9 in that it does not include a security processing module 352. However, unlike the implementation of FIG. 9, communications interface 350 receives protected superdistribution key 1106 from content distributor 104 and forwards it to storage medium 354.

As shown in FIG. 12, storage medium 354 sends protected content item 1102, protected superdistribution key 1106, and protected usage rules 1108 to second communications interface 356 for transmission to second device 110. However, in alternative implementations, this information may be sent directly from first communications interface 350 to second communications interface 356.

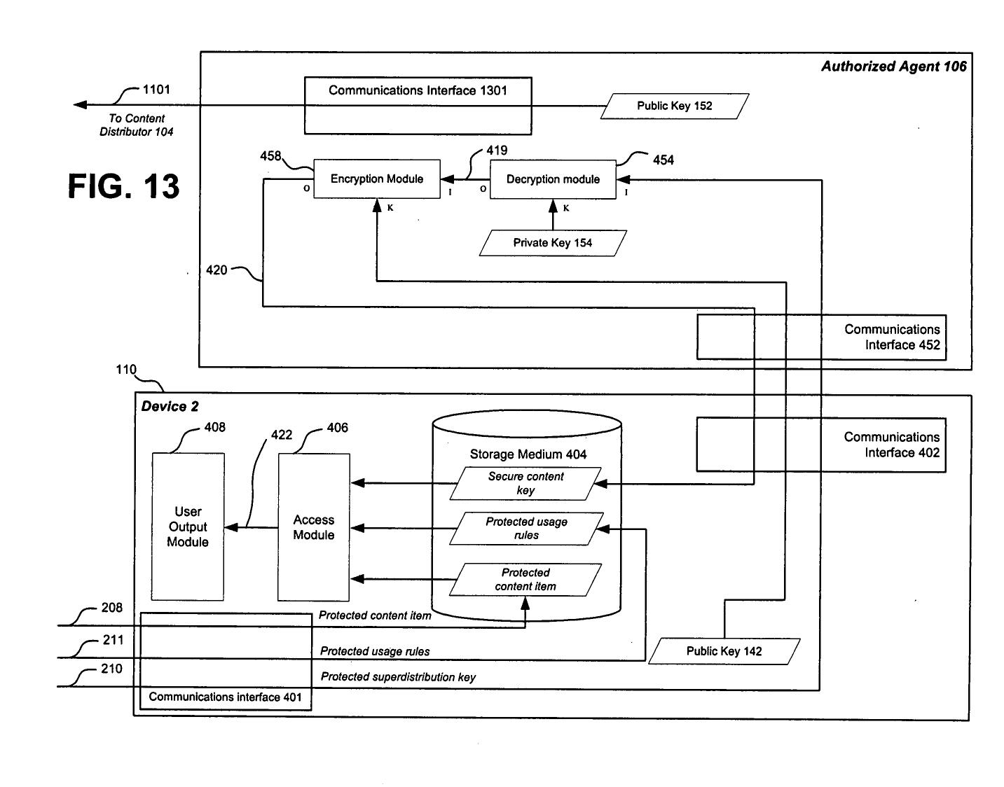

FIG. 13 is a block diagram showing exemplary implementations of second device 110 and authorized agent 106 that may be employed in the scenario of FIG. 11. In addition, FIG. 13 shows interactions between second device 110 and authorized agent 106 according to this scenario.

The implementations of FIG. 13 are similar to the implementations of FIG. 4A. However, in FIG. 13, the implementation of authorized agent 106 includes a communications interface 1301. Communications interface 1301 provides for the exchange of information between authorized agent 106 and content distributor 104. This interface may be implemented in hardware, software, firmware, or any combination thereof. As shown in FIG. 13, communications interface 1301 sends public key 152 to content distributor 104 in the form of transmission 1101.

E. Further Scenarios

Although four scenarios have been described above, other scenarios are within the scope of the present invention. For instance, as described above with reference to FIG. 3, content distributor 104 may employ conditional access (CA) protection in transmitting information to first device. However, the other scenarios may also employ CA protection. In addition, other scenarios may allow for authorized agent 106 to receive and modify usage rules, as described above with reference to FIG. 4B. Also, while the above scenarios describe usage rules being transferred and processed. These usage rules may be included in vouchers.

Moreover, in scenarios where content distributor 104 transmits CA protected content, first device 108 may process the content and transfer it to second device 110, without descrambling it. This results in a double encryption feature. Accordingly, to process such double encrypted information, implementations of second device 110 and authorized agent 106 may have descrambling capabilities and receive CA encryption keys from content distributor 104.

Also, in the scenarios described above, the content key is encrypted with public key 124 of first device 108 to produce a protected content key. However, the content key may alternatively be encrypted with a domain key. Thus, if device 110 belongs to the same domain as first device 108, it may receive this encrypted content key and decrypt it without ever receiving a superdistribution key or engaging in communications with an authorized agent. However, if second device 110 does not belong to the same domain as first device 108, it may employ the techniques described above to obtain the content key.

F. Digital Certificates

The scenarios described above involve the transfer and use of secret information, such as content keys. To ensure that such secret information is encrypted with a public key, the public keys of devices, such as authorized agent 106 and second device 110, may be transferred to other devices in digital certificates. This verifies that the public keys belong to these devices and establishes these devices as trusted entities.

The devices in the above scenarios may employ a certificate authority (not shown) to embed their public keys in a digital certificate. In embodiments, the certificate authority creates such certificates by encrypting a device's public key (as well as other identifying information) such that it may be decrypted using the certificate authority's public key. This public key is publicly available (e.g., through the Internet). When a device receives a digital certificate, it may obtain the sender's public key by decrypting certificate with the certificate authority's public key.

III. Access and Output Modules

As described above, first device 108 and second device 110 may each include an access module and a user output module. An example of these modules is shown in FIG. 14.

As shown in FIG. 14, an access module 1402 includes decryption modules 1414, 1416, and 1418. In addition, access module 1402 includes a rendering engine 1420 coupled to decryption modules 1416 and 1418. These elements may be implemented in hardware, software, firmware, or in any combination thereof.

Each of decryption modules 1414, 1416, and 1418 has an input interface (indicated with an “I”) for receiving encrypted data, and an input interface (indicated with a “K”) for receiving an encryption key. In addition, each of these modules includes an output interface (indicated with an “O”) for outputting decrypted data.

Access module 1402 receives secure content key 1406, protected content item 1408, and protected usage rules 1410. Secure content key 1406 is a content key encrypted with a public key of the device in which access module 1402 is implemented. As shown in FIG. 14, decryption module 1414 decrypts secure content key 1406 with a corresponding private key 1412 of the device in which access module 1402 is implemented. This decryption produces a content key 1407.

FIG. 14 shows that decryption module 1416 receives protected content item 1408 and content key 1407 to generate content item 1450. Decryption module 1418 receives protected usage rules 1410 and content key 1407 to generate usage rules 1452. This generation may be based on symmetric encryption techniques, since content key 1407 may have also been used to generate protected content item 1408, and protected usage rules 1410.

Content item 1450 and usage rules 1452 are sent to rendering engine, where content item is decoded or rendered into an output signal 1454. This decoding or rendering is subject to any restrictions or conditions of usage rules 1452.

FIG. 14 shows that user output module 1404 may include one or more displays 1422, and one or more speakers 1424 for outputting signal 1454 to a user. However, user output module 1404 may include other devices, as would be apparent to persons skilled in the relevant arts.

IV. Process

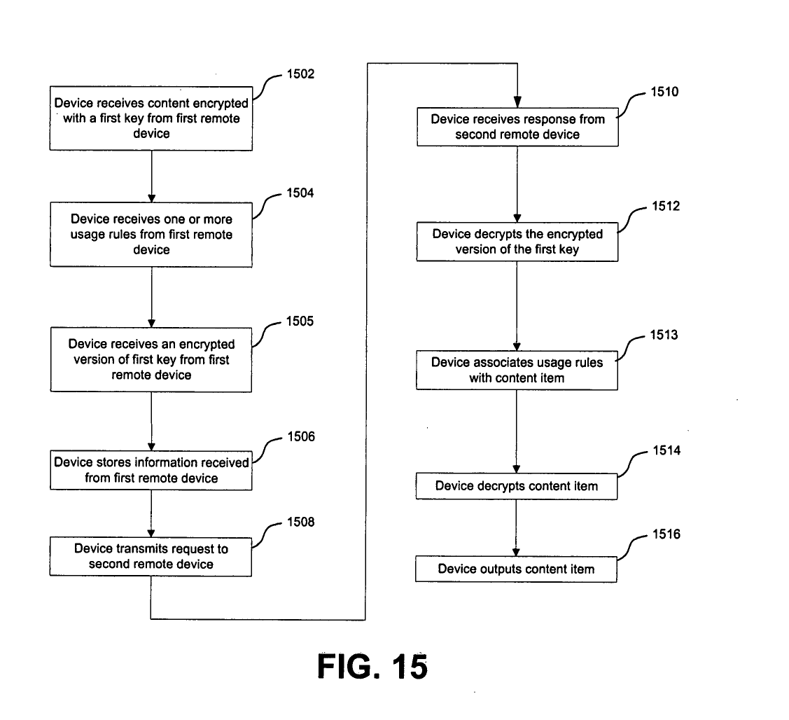

FIG. 15 is a flowchart of a process according to an embodiment of the present invention. Examples of this process are described above with reference to FIGS. 2-13. However, this process may be performed in other environments, topologies, and scenarios.

As shown in FIG. 15, this process includes a step 1502. In this step, a device, such as second device 110, receives content from a first remote device, such as first device 108. Accordingly, this device is referred to herein as “the content receiving device.” This received content is encrypted with a first encryption key.

The process of FIG. 15 may include optional steps 1504 and 1505. In optional step 1504, the content receiving device may receive one or more usage rules from the first remote device. These usage rules may be expressed in a voucher. Like the content received in step 1502, the one or more received usage rules are encrypted with the first encryption key. In optional step 1505, the content receiving device may receive an encrypted version of the first encryption key from the first remote device. If received, this encrypted version may be encrypted with a key corresponding to a second remote device, such as an authorized agent. For example, this key may be a public key of the second remote device.

In an optional step 1506, the content receiving device may store the content received in step 1502, as well as any usage rules received in step 1504 (if performed). Also, the content receiving device may store the encrypted version of the first key received in step 1505 (if performed). Although FIG. 15 shows step 1506 following step 1502, 1504, and 1505, this step may be performed in other sequences.

In a step 1508, the content receiving device transmits a request for the first encryption key to the second remote device. The request may include a second encryption key. This second encryption key may be associated with the content receiving device. For instance, the second encryption key may be a public key of the content receiving device.

The request transmitted in step 1508 may also include other information. For instance, if optional step 1504 is performed, the request may include the one or more encrypted usage rules received in that step. These usage rules may be expressed in a voucher. Similarly, if optional step 1505 is performed, the request may include the encrypted version of the first encryption key received in that step.

A step 1510 follows step 1508. In this step, the content receiving device receives a response from the second remote device. This response includes an encrypted version of the first encryption key. This encrypted version is encrypted with the second encryption key. As described above with reference to step 1508, this second encryption key may be associated with the content receiving device. For instance, the second encryption key may be a public key of the content receiving device.

If the request of step 1508 included one or more encrypted usage rules, then the response received in step 1510 may also include one or more usage rules. These usage rules may expressed in a voucher. In addition, these usage rules may be encrypted with a key associated with the content receiving device, such as its public key. These received usage rules may have been modified by the second remote device.

In a step 1512, the content receiving device decrypts the encrypted version of the first encryption key with a third encryption key. The third encryption key corresponds to the second encryption key. In embodiments, the second and third encryption keys may be associated with the content receiving device. For example, the second encryption key may be a public key of the content receiving device and the third encryption key may be a private key of the content receiving device.

After step 1512 is performed, the content receiving device may perform optional steps 1513, 1514 and 1516.

Step 1513 may be performed when the response received in step 1510 includes one or more usage rules. In step 1513, the content receiving device associates the usage rules received in step 1510 with the content received in step 1502. This step may include decrypting the usage rules (or voucher) with a key that corresponds to the key in which the received usage rules are encrypted. The key used for this decryption may be the private key of the content receiving device. Once decrypted, may access any data in the usage rules (or voucher) which identifies the corresponding content item.

In step 1514, the content receiving device decrypts the content received in step 1502 with the first content key decrypted in step 1512. In optional step 1516, the content receiving device outputs the content decrypted in step 1514 to a user of the content receiving device.

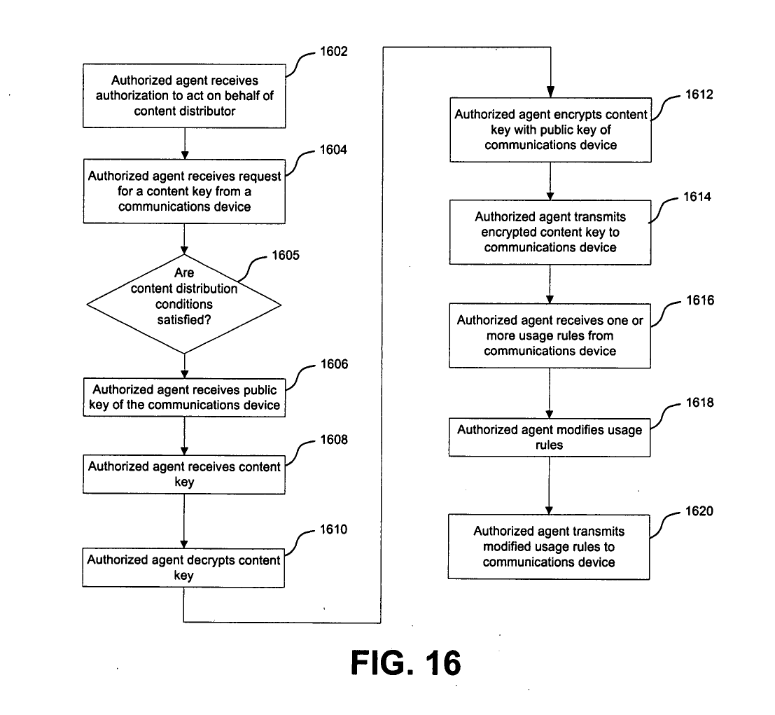

FIG. 16 is a flowchart of an operational sequence that may be performed by a device, such as authorized agent 106. This sequence includes multiple steps, which may be performed in a variety of orders. Also, modifications to this sequence, such as the performance of additional steps, may be made.

In a step 1602, the authorized agent receives authorization to act on behalf of a content distributor, such as content distributor 104. For example, this step may include the authorized agent receiving an authorization message from the content distributor via a network, such as network 126. Accordingly, the authorized agent may include a communications interface (such as communications interfaces 702 and 1001) for exchanging information with the content distributor.

In a step 1604, the authorized agent receives a request for a content key from a communications device, such as device 110. Next, in a step 1605, the authorized agent determines whether one or more one or more content distribution conditions are satisfied. An example of such a condition includes receipt of a payment from the communications device. If such conditions are satisfied, operation proceeds to a step 1606.

In step 1606, the authorized agent receives a public key of the communications device. This key may be received from the communications device. For example, this public key may be received as part of the request of step 1604.

In a step 1608, the authorized agent receives the content key in an encrypted form. This encrypted content is encrypted with a public key of the authorized agent. The authorized agent may receive this key from the communications device. For example, this content key may be received as part of the request of step 1604. Alternatively, this content key may be received from other devices, such as the content distributor.

In a step 1610, the authorized agent decrypts the content key encrypted with the public key of the authorized agent. In a step 1612, the authorized agent encrypts the content key with a public key of the communications device.

A step 1614 follows step 1612. In this step, the authorized agent transmits the content key encrypted in step 1612 to the communications device.

As described above, the present invention provides for the modification of usage rules. Accordingly, in a step 1616, the authorized agent may receive one or more usage rules from the communications device. These usage rules correspond to the content item.

In a step 1618, the authorized agent modifies the usage rule(s) received in step 1616. Such modifications may be subject to one or more modification limitations. Examples of modification limitations include temporal limitations that permit modification only during a specified time interval, content type limitations that permit usage rule modifications for only certain types of content (e.g., video broadcasts), and specific limitations that permit usage rule modifications for only particular content items. Such modification limitations may be received from the content distributor, for example, in the authorization of step 1602.

When received, the one or more usage rules may be encrypted with the public key of the authorized agent. Accordingly, step 1618 may also include decrypting the usage rules with the corresponding private key of the authorized agent.

In a step 1620, the authorized agent transmits the modified usage rule(s) to the communications device. These modified usage rules may be encrypted with the public key of the communications device. Thus, step 1618, may include encrypting these modified usage rules with the public key of the communications device.

V. Computer System

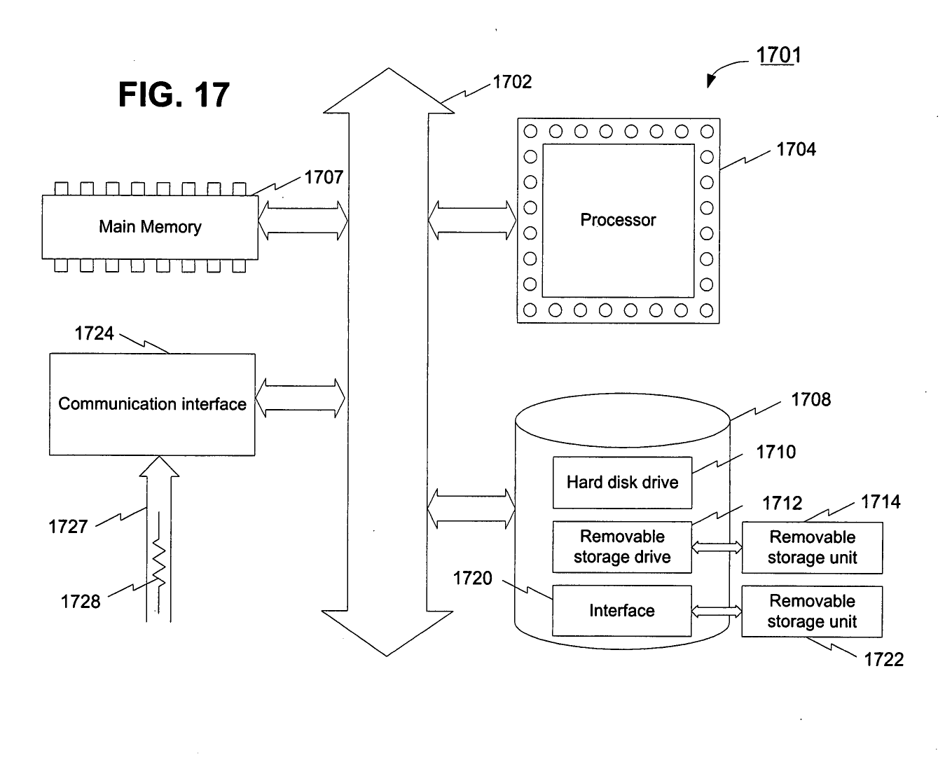

As described above, devices 104, 106, 108, and 110 may include software components. Accordingly, these devices may be implemented with one or more computer systems. An example of a computer system 1701 is shown in FIG. 17. Computer system 1701 represents any single or multi-processor computer. Single-threaded and multi-threaded computers can be used. Unified or distributed memory systems can be used.

Computer system 1701 includes one or more processors, such as processor 1704. One or more processors 1704 can execute software implementing the functionality described above. Each processor 1704 is connected to a communication infrastructure 1702 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1701 also includes a main memory 1707 which is preferably random access memory (RAM). Computer system 1701 may also include a secondary memory 1708. Secondary memory 1708 may include, for example, a hard disk drive 1710 and/or a removable storage drive 1712, representing a floppy disk drive, a magnetic tape drive, an optical disk drive, etc. Removable storage drive 1712 reads from and/or writes to a removable storage unit 1714 in a well known manner. Removable storage unit 1714 represents a floppy disk, magnetic tape, optical disk, etc., which is read by and written to by removable storage drive 1712. As will be appreciated, the removable storage unit 1714 includes a computer usable storage medium having stored therein computer software and/or data.

In alternative embodiments, secondary memory 1708 may include other similar means for allowing computer programs or other instructions to be loaded into computer system 1701. Such means can include, for example, a removable storage unit 1722 and an interface 1720. Examples can include a program cartridge and cartridge interface (such as that found in video game devices), a removable memory chip (such as an EPROM, PROM, or flash memory) and associated socket, and other removable storage units 1722 and interfaces 1720 which allow software and data to be transferred from the removable storage unit 1722 to computer system 1701.

Computer system 1701 may also include a communications interface 1724. Communications interface 1724 allows software and data to be transferred between computer system 1701 and external devices via communications path 1727. Examples of communications interface 1727 include a modem, a network interface (such as Ethernet card), Bluetooth and/or other short-range wireless network modules, etc. Software and data transferred via communications interface 1727 are in the form of signals 1728 which can be electronic, electromagnetic, optical or other signals capable of being received by communications interface 1724, via communications path 1727. Note that communications interface 1724 provides a means by which computer system 1701 can interface to a network such as the Internet.

The present invention can be implemented using software running (that is, executing) in an environment similar to that described above with respect to FIG. 17. In this document, the term “computer program product” is used to generally refer to removable storage units 1714 and 1722, a hard disk installed in hard disk drive 1710, or a signal carrying software over a communication path 1727 (wireless link or cable) to communication interface 1724. A computer useable medium can include magnetic media, optical media, or other recordable media, or media that transmits a carrier wave or other signal. These computer program products are means for providing software to computer system 1701.

Computer programs (also called computer control logic) are stored in main memory 1707 and/or secondary memory 1708. Computer programs can also be received via communications interface 1724. Such computer programs, when executed, enable the computer system 1701 to perform the features of the present invention as discussed herein. In particular, the computer programs, when executed, enable the processor 1704 to perform the features of the present invention. Accordingly, such computer programs represent controllers of the computer system 1701.

The present invention can be implemented as control logic in software, firmware, hardware or any combination thereof. In an embodiment where the invention is implemented using software, the software may be stored in a computer program product and loaded into computer system 1701 using removable storage drive 1712, hard drive 1710, or interface 1720. Alternatively, the computer program product may be downloaded to computer system 1701 over communications path 1727. The control logic (software), when executed by the one or more processors 1704, causes the processor(s) 1704 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

### VI. Conclusion

While various embodiments of the present invention have been described above, it should be understood that they have been presented by way of example only, and not limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of processing information in a communications device, comprising:
(a) receiving from a first remote device content encrypted with a content key;
(b) transmitting a request for the content key to a second remote device, the second remote device authorized to act on behalf of a provider of the content;
(c) receiving from the second remote device an encrypted version of the content key, wherein the encrypted version of the content key is encrypted with a public key of the communications device; and
(d) decrypting the encrypted version of the content key with a private key of the communications device, the private key of the communications device corresponding to the public key of the communications device.

2. The method of claim 1, wherein step (b) comprises transmitting the public key of the communications device to the second remote device.

3. The method of claim 1, further comprising:
receiving from the first remote device the content key encrypted with a public key of the second remote device.

4. The method of claim 3, wherein step (b) comprises transmitting to the second remote device the content key encrypted with the public key of the second remote device.

5. The method of claim 4, wherein step (b) further comprises transmitting to the second remote device the public key of the communications device.

6. The method of claim 1, further comprising:
receiving one or more usage rules from the first remote device, wherein the usage rules correspond to the content;
transmitting the one or more usage rules to the second remote device;
receiving one or more modified usage rules from the second remote device; and
associating the one or more modified usage rules with the content.

7. A communications device, comprising:
a first communications interface adapted to receive from a first remote device content encrypted with a content key;
a module adapted to decrypt an encrypted version of the content key with a private key of the communications device; and
a second communications interface adapted to
(a) transmit a request for the content key to a second remote device, the second remote device authorized to act on behalf of a provider of the content, and
(b) receive from the second remote device an encrypted version of the content key, wherein the encrypted version of the content key is encrypted with a public key of the communications device, the public key of the communications device corresponding to the private key of the communications device.

8. The device of claim 7, wherein the request includes the public key of the communications device.

9. The device of claim 7, wherein the first communications interface is further adapted to receive from the first remote device the content key encrypted with a public key of the second remote device.

10. The device of claim 9, wherein the request includes the content key encrypted with the public key of the second remote device.

11. The device of claim 10, wherein the request includes the public key of the communications device.

12. The device of claim 7, wherein the first communications interface is further adapted to receive one or more usage rules from the first remote device, the usage rules corresponding to the content; and
wherein the second communications interface is further adapted to transmit the one or more usage rules to the second remote device; and to receive one or more modified usage rules from the second remote device.

13. A communications device, comprising:
means for receiving from a first remote device content encrypted with a content key;
means for transmitting a request for the content key to a second remote device, the second remote device authorized to act on behalf of a provider of the content;
means for receiving from the second remote device an encrypted version of the content key, wherein the encrypted version of the content key is encrypted with a public key of the communications device; and
means for decrypting the encrypted version of the content key with a private key of the communications device, the private key of the communications device corresponding to the public key of the communications device.

14. A system, comprising:
a communications device adapted to receive from a remote device a content item encrypted with a content key; and
an authorized agent authorized to act on behalf of a content distributor, the authorized agent adapted to provide the content key to the communications device.

15. The system of claim 14, wherein the communications device is further adapted to transmit a request for the content key to the authorized agent.

16. The system of claim 15, wherein the request includes a public key of the communications device.

17. The system of claim 15, wherein the request includes the content key encrypted with a public key of the authorized agent.

18. The system of claim 14, wherein the authorized agent is further adapted to provide to the communications device the content key encrypted with a public key of the communications device.

19. The system of claim 14, further comprising the content distributor.

20. The system of claim 19, further comprising the remote device;
wherein the remote device receives the content item from the content distributor.

21. The system of claim 14, wherein the communications device, the remote device, and the authorized agent communicate with each other across one or more wireless communications networks.

22. A method of facilitating distribution of content among devices in an authorized agent, comprising:
(a) receiving authorization to act on behalf of a content distributor;
(b) receiving from a communications device a request for a content key, the content key for decrypting a content item originally distributed by the content distributor;
(c) encrypting the content key with a public key of the communications device; and
(d) transmitting to the communications device the content key encrypted with the public key of the communications device.

23. The method of claim 22, further comprising:
(e) receiving the content key encrypted with a public key of the authorized agent.

24. The method of claim 23, wherein step (e) comprises receiving the content key encrypted with the public key of the authorized agent from the communications device.

25. The method of claim 23, wherein step (e) comprises receiving the content key encrypted with the public key of the authorized agent from the content distributor.

26. The method of claim 23, wherein step (b) comprises receiving the public key of the communications device.

27. The method of claim 26, further comprising:
decrypting the content key encrypted with the public key of the authorized agent; and
encrypting the content key with the public key of the communications device.

28. The method of claim 22, further comprising:
receiving one or more usage rules from the communications device, the one or more usage rules corresponding to the content item;
modifying the one or more usage rules; and
transmitting the one or more modified usage rules to the communications device.

29. The method of claim 28, wherein said modifying step is performed in accordance with one or more modification limitations.

30. The method of claim 29, wherein the one or more modification limitations includes at least one of a temporal limitation, a content type limitation, and a specific content limitation.

31. The method of claim 29, wherein the one or more modification limitations are imposed by the content distributor.

32. The method of claim 28, wherein the one or more usage rules are encrypted with a public key of the authorized agent.

33. The method of claim 28, wherein the one or more modified usage rules are encrypted with a public key of the communications device.

34. The method of claim 22, wherein step (d) is performed when one or more content distribution conditions are satisfied.

35. The method of claim 34, wherein the one or more content distribution conditions includes a payment from the communications device.

36. An authorized agent, comprising:
a first communications interface adapted to receive authorization to act on behalf of the content distributor;
a module adapted to encrypt a content key with a public key of the communications device, the content key for decrypting a content item originally distributed by the content distributor; and
a second communications interface adapted to receive from a communications device a request for the content key, and transmit to the communications device the content key encrypted with the public key of the communications device.

37. The authorized agent of claim 36, wherein the request includes the content key encrypted with a public key of the authorized agent.

38. The authorized agent of claim 36, wherein the first communications interface is further adapted to receive the content key encrypted with a public key of the authorized agent from the content distributor.

39. The authorized agent of claim 37, wherein the request further includes the public key of the communications device.

40. The authorized agent of claim 39, further comprising a module adapted to decrypt the content key encrypted with the public key of the authorized agent.

41. The authorized agent of claim 36, further comprising a rules module adapted to modify one or more usage rules received from the communications device; and
wherein the second communications interface is further adapted to send the one or more modified rules to the communications device.

42. The authorized agent of claim 41, wherein said rules module is further adapted to modify the one or more usage rules in accordance with one or more modification limitations.

43. The authorized agent of claim 42, wherein the one or more modification limitations includes at least one of a temporal limitation, a content type limitation, and a specific content limitation.

44. The authorized agent of claim 42, wherein the one or more modification limitations are imposed by the content distributor.

45. The authorized agent of claim 41, wherein the one or more usage rules are encrypted with a public key of the authorized agent.

46. The authorized agent of claim 41, wherein the one or more modified usage rules are encrypted with a public key of the communications device.

47. The authorized agent of claim 36, wherein said second communications interface is further adapted to transmit the content key encrypted with the public key of the communications device when one or more content distribution conditions are satisfied.

48. The authorized agent of claim 47, wherein the one or more content distribution conditions includes a payment from the communications device.

49. A system, comprising:
means for receiving authorization to act on behalf of a content distributor;
means for receiving from a communications device a request for a content key, the content key for decrypting a content item originally distributed by the content distributor;
means for encrypting the content key with a public key of the communications device; and
means for transmitting to the communications device the content key encrypted with the public key of the communications device.

50. A system, comprising:
a content distributor adapted to transmit a digital television broadcast along with a public encryption key of an authorized agent, the authorized agent authorized to act on behalf of the content distributor; and
a communications device adapted to receive the digital television broadcast and the public encryption key from the content distributor;
wherein the communications device is further adapted to encrypt the digital television broadcast with an internally generated content key, and to encrypt the internally generated content key with the public key of the authorized agent.

51. A communications device, comprising:
a communications interface adapted to receive from a content distributor a digital television broadcast and a public encryption key of an authorized agent, the authorized agent authorized to act on behalf of the content distributor; and
a security processing module adapted to encrypt the digital television broadcast with an internally generated content key, and to encrypt the internally generated content key with the public key of the authorized agent.
